(19) United States
(12) Patent Application Publication
(10) Pub. No.: US 2015/0069966 A1
(43) Pub. Date: Mar. 12, 2015

(54) Camera cases and bags with integrated charging system

(71) Applicant: Jeffrey Overall, Fountain Valley, CA (US)

(72) Inventor: Jeffrey Overall, Fountain Valley, CA (US)

(21) Appl. No.: 14/544,021

(22) Filed: Nov. 13, 2014

(51) Int. Cl. H02J 7/00; H02J 7/35; H01M 2/10; H02J 7/02

(52) U.S. Cl. CPC H02J 7/0042; H02J 7/0052; H02J 7/025; H02J 7/35; H01M 2/1022
USPC 320/108; 320/107; 429/98

(57) ABSTRACT

The present invention is generally directed to cases and bags for the storage and/or protection of cameras. It is more specifically directed to such cases and bags that include an integrated charging system. In one aspect, the present invention is directed to a camera case or bag. The case or bag includes the following: a case bottom, wherein the case bottom comprises a built in energy storage system and at least one camera storage section, and wherein the energy storage system can be operably connected to a camera placed in the camera storage section; a case cover connected to the case bottom, such that the case cover can be closed on the case bottom.

### FIELD OF THE INVENTION

The present invention is generally directed to cases and bags for the storage and/or protection of cameras. It is more specifically directed to such cases and bags that include an integrated charging system.

### BACKGROUND OF THE INVENTION

Certain cases and bags for the storage and/or protection of cameras are known. For instance, U.S. Pat. No. 8,718,457, entitled “Camera Case”, is allegedly directed to the following invention: “Disclosed camera cases are configured to be positioned around a camera such that the camera is retained within the case while remaining operable. The case can have a generally cuboid shape with front, rear, top, bottom, left and right sides. At least two of these sides can comprise at least one mounting feature, such as a threaded hole. The rear side can comprise a door configured to allow a camera to be inserted into the case. The rear door can comprise an adjustable portion that can be coupled to the rear door in at least two different positions, such that the case is adjustable to be used with cameras of different sizes. A trigger button on a side of the case can be configured to activate a camera button positioned on a top side of a camera within the case. The case can be dirt and moisture resistant.” Abstract.

U.S. Pat. No. 8,544,643, entitled “Waterproof Camera Case With A Lock”, is allegedly directed to the following invention: “A waterproof camera case includes first and second case members and a lock mechanism for locking the first and second case members together. The lock mechanism includes a side flip hingedly connected to a side of the rear case member and moveable between a flip open position and a flip closed position where an inner surface of the side flip abuts against a side of the front case member. A press member is pivotable about a first shaft mounted on the inner surface of the side flip and moveable between a non-pressing position and a pressing position. A free distal side of the press member is configured to press against a ledge projected from the side of the front case member on a surface oppositely facing the rear casemember. A lock member is slidable along a second shaft mounted on the inner surface of the side flip and moveable between an unlocked position and a locked position. The lock member has a latch portion adapted to insert into a slot defined by a catch portion formed on the side of the front case member. A torsion spring is used to bias the press member in the non-pressing position, and a compression spring is used to bias the lock member in the locked position.”

U.S. Pat. No. 8,424,680, entitled “Camera Case with Selective Lens Storage”, is allegedly directed to the following invention: “A camera storage case is provided that includes a camera support system. The camera support system may be made of EVA foam and made to conform to the exterior perimeter surface of the camera. The camera support system may also include a tube to protect the camera's interconnected lens. The storage case can be configured as a backpack, messenger bag, or holster. Flexible lens holders are included in the storage case to facilitate easy access to stored lenses. Furthermore, the storage case provides dividing walls to allow the user to selectively configure the interior storage compartment of the camera case.” Abstract.

Despite the certain cases and bags for the storage and/or protection of cameras, there is still a need for new types of cases and bags.

### BRIEF DESCRIPTION OF THE FIGURES

FIG. 1 shows a top view of one embodiment of an open case according to the invention.

FIG. 2 shows a side view of one embodiment of an open case according to the invention.

FIG. 3 shows a bottom view of one embodiment of a closed case according to the invention.

FIG. 4 shows a side view of one embodiment of a closed case according to the invention.

FIG. 5 shows a side view of one embodiment of a closed case according to the invention.

FIG. 6 shows a side view of one embodiment of a closed case according to the invention.

FIG. 7 shows a top view of one embodiment of an open case according to the invention.

FIG. 8 shows a top view of one embodiment of an open case according to the invention.

FIG. 9 shows a top view of one embodiment of an open case according to the invention.

FIG. 10 shows a top view of one embodiment of an open case according to the invention.

FIG. 11 shows a cut-away side view of one embodiment of a closed case according to the invention.

FIG. 12 shows a cut-away bottom view of one embodiment of a closed case according to the invention.

FIG. 13 shows a top view of one embodiment of an open bag according to the invention.

FIG. 14 shows a side view of one embodiment of a closed bag according to the invention.

FIG. 15 shows a front view of one embodiment of a closed bag according to the invention.

FIG. 16 shows a side view of one embodiment of an open bag according to the invention.

FIG. 17 shows a side view of one embodiment of an open bag where the outside of the bag has been cut away.

FIG. 18 shows a top view of one section of an embodiment according to the invention, where the section is capable of holding a camera.

FIG. 19 shows a top view of one section of an embodiment according to the invention, where the section includes a power source (e.g., battery).

FIG. 20 shows a cut away, side view of an embodiment according to the invention.

### SUMMARY OF THE INVENTION

In one aspect, the present invention is directed to a camera case or bag. The case or bag includes the following: a case bottom, wherein the case bottom comprises a built in energy storage system and at least one camera storage section, and wherein the energy storage system can be operably connected to a camera placed in the camera storage section; a case cover connected to the case bottom, such that the case cover can be closed on the case bottom.

### DETAILED DESCRIPTION OF THE INVENTION

The present invention is generally directed to cases and bags for the storage and/or protection of cameras. It is more specifically directed to such cases and bags that include an integrated charging system. That the portion of the case/bag that is denoted as “top” or “bottom” is only for reference in relation to figure elements should be understood. One could, of course, flip the case/bag over such that the “bottom” became the “top”.

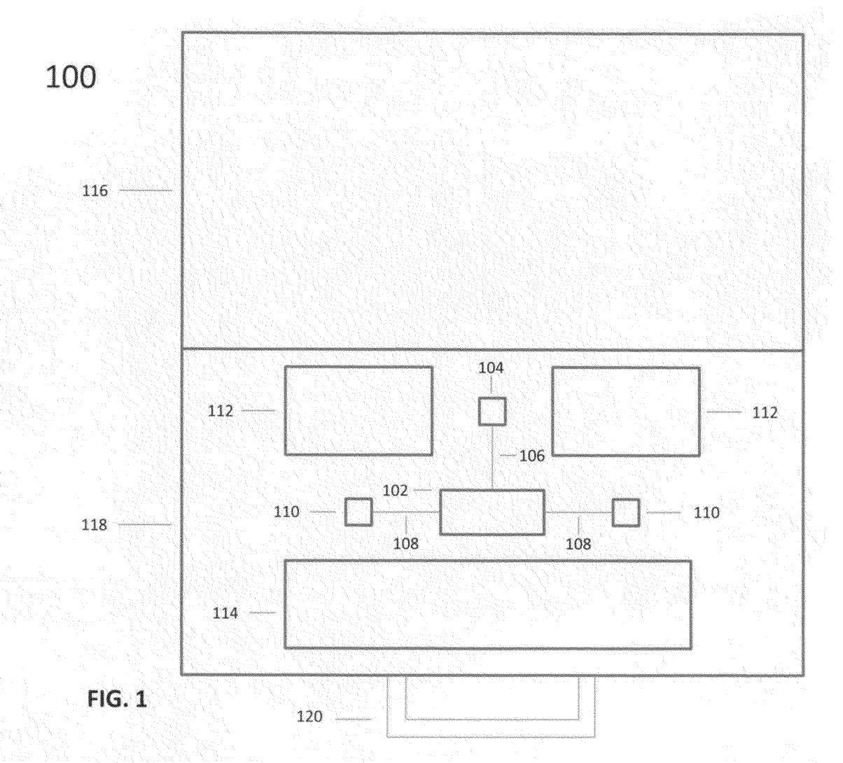

FIG. 1 shows a top view of one embodiment of an open case (100) according to the invention. Case bottom 118, as shown, includes a built in energy storage system 102 (e.g., battery), which can be charged through a charge input (104). The charge provided to charge input 104 can be from any suitable device, including, without limitation, the following: a USB; a mini USB; a micro USB; and a 9 V battery. Power-in bridge 106 transfers power from charge input 104 to energy storage system 102. One or more (e.g., two) power-out bridges 108 transfer power from energy storage system 102 to one or more charge out slots 110, which can connect to one or more cameras. The charge out slots can be of any suitable form, including, without limitation, the following: a USB; mini USB; micro USB; 9V out battery slot to charge batteries directly; camera dock to plug in camera directly. Case bottom 118 further includes one or more (e.g., two) camera storage sections 112, which can be of any suitable shape. One or more accessory storage sections 114 are optionally included—also of any suitable shape—as well as an optional handle 120. Case cover 116 is attached to case bottom 118 through a mechanism allowing it to open and close in connection with the bottom (e.g., hinge, zipper, straps, clips, locks, clamps). In certain embodiments case cover 116 is detachable; in others it is not.

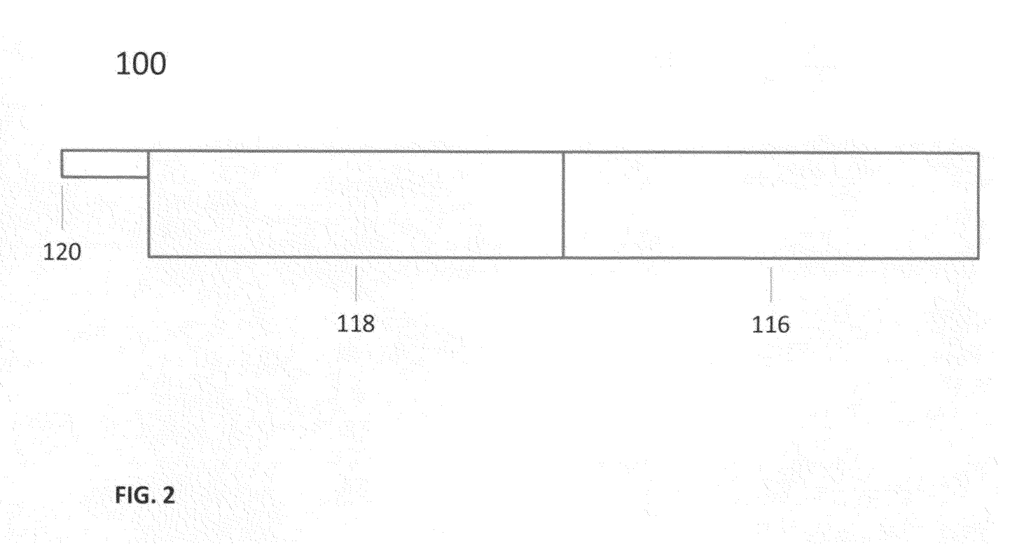

FIG. 2 shows a side view of one embodiment of an open case according to the invention. Case bottom 118 is connected to case cover 116. As shown, optional handle 120 is connected to case bottom 118.

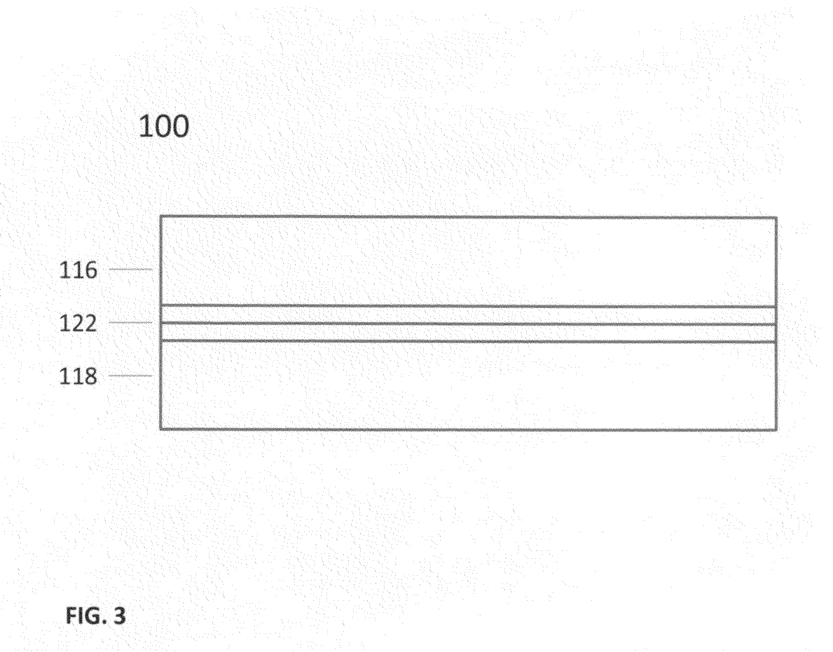

FIG. 3 shows a bottom view of one embodiment of a closed case according to the invention. Case bottom 118 is connected to case cover 116 through hinge 122.

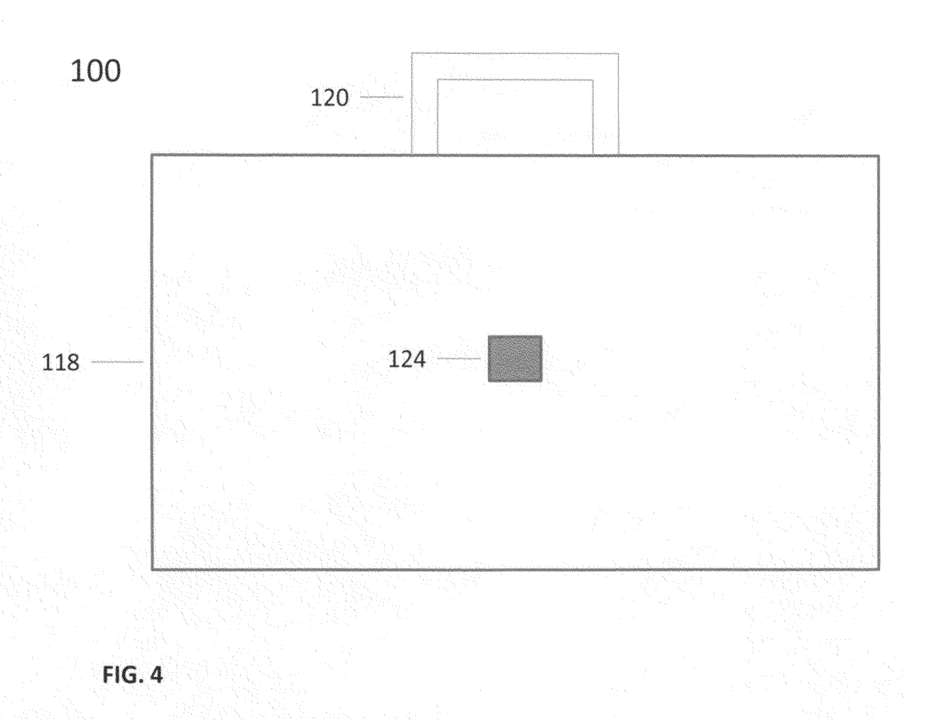

FIG. 4 shows a side view of one embodiment of a closed case according to the invention. Optional handle 120 is shown attached to case bottom 118. Charge inlet 124, which is built into case bottom 118, allows an energy source to be connected directly to the outside of case 100. Inlet 124 is connected to charge input 104 (not shown).

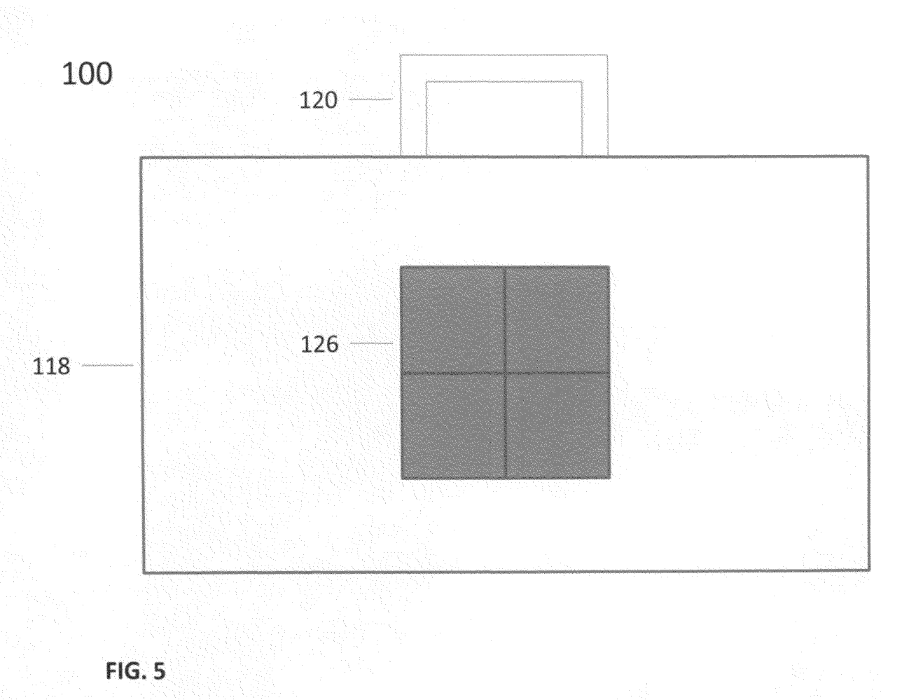

FIG. 5 shows a side view of one embodiment of a closed case according to the invention. Optional handle 120 is shown attached to case bottom 118. Solar panel 126, which is built into case bottom 118, provides energy to charge input 104 (not shown).

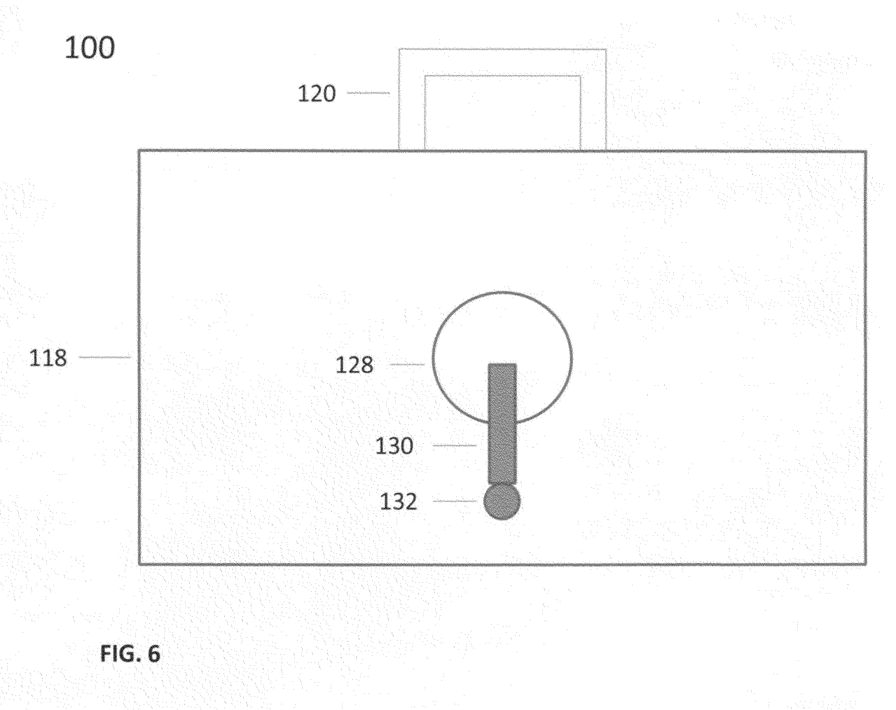

FIG. 6 shows a side view of one embodiment of a closed case according to the invention. Optional handle 120 is shown attached to case bottom 118. A power generating mechanism is built into case bottom 118, consisting of dynamo 128 which is connected to arm 130. Arm 130 is connected to crank handle 132. Electricity is generated by rotating crank handle at a particular speed for a particular length of time. The power generating mechanism provides energy to charge input 104 (not shown).

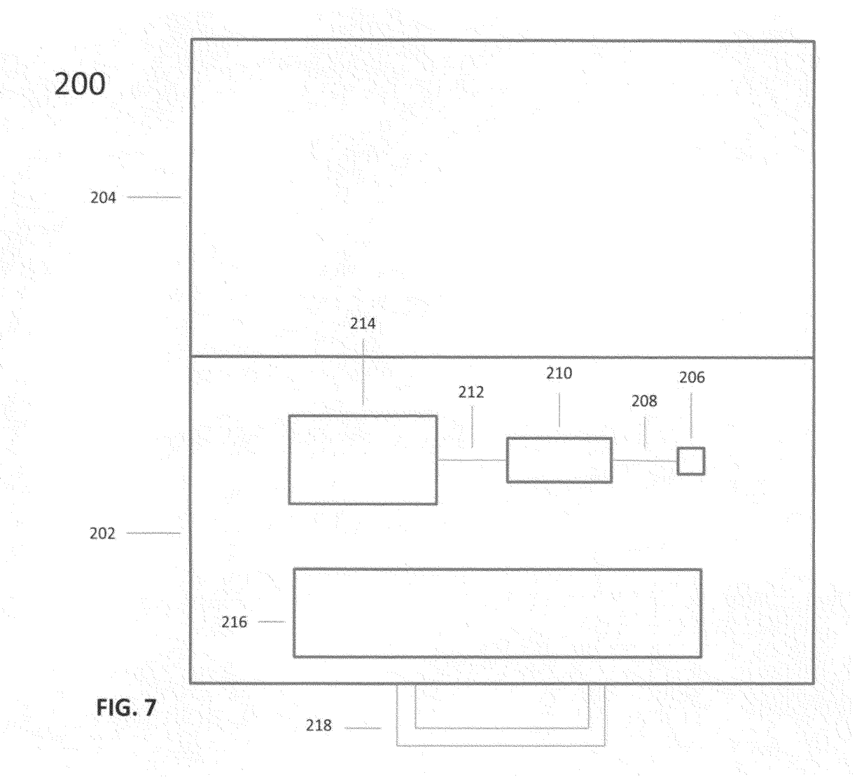

FIG. 7 shows a top view of one embodiment of an open case (200) according to the invention. Case bottom 202, as shown, includes a built in energy storage system 210 (e.g., battery), which can be charged through a charge input (206). The charge provided to charge input 206 can be from any suitable device, including, without limitation, the following: a USB; a mini USB; a micro USB; and a 9 V battery. Power-in bridge 208 transfers power from charge input 206 to energy storage system 210. A power-out bridge 212 transfers power from energy storage system 210 directly to camera storage section 214, which will allow direct power transfer to a camera positioned in the section (not shown). One or more accessory storage sections 216 are optionally included, as well as an optional handle 218. Case cover 204 is attached to case bottom 202 through a mechanism allowing it to open and close in connection with the bottom (e.g., hinge). In certain embodiments case cover 204 is detachable; in others it is not.

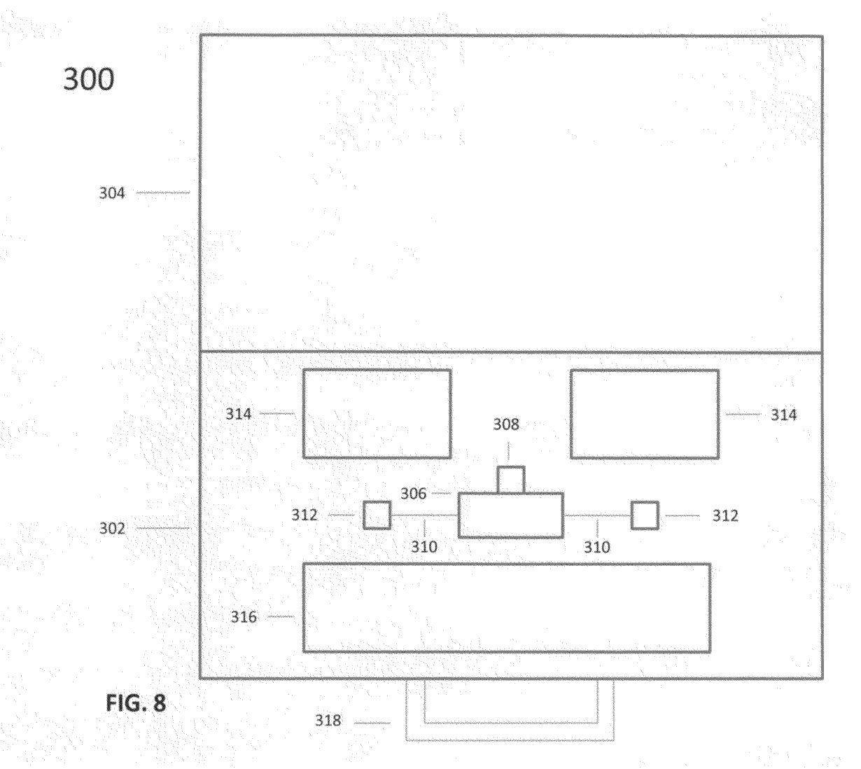

FIG. 8 shows a top view of one embodiment of an open case (300) according to the invention. Case bottom 302, as shown, includes a built in energy storage system 306 (e.g., battery), which can be charged through a charge input (308), which is directly connected to energy storage system 306. The charge provided to charge input 308 can be from any suitable device, including, without limitation, the following: a USB; a mini USB; a micro USB; and a 9 V battery. One or more (e.g., two) power-out bridges 310 transfer power from energy storage system 306 to one or more charge out slots 312, which can connect to one or more cameras. The charge out slots can be of any suitable form, including, without limitation, the following: a USB; mini USB; micro USB; 9V out battery slot to charge batteries directly; camera dock to plug in camera directly. Case bottom 302 further includes one or more (e.g., two) camera storage sections 314, which can be of any suitable shape. One or more accessory storage sections 316 are optionally included—also of any suitable shape—as well as an optional handle 318. Case cover 304 is attached to case bottom 302 through a mechanism allowing it to open and close in connection with the bottom (e.g., hinge). In certain embodiments case cover 304 is detachable; in others it is not.

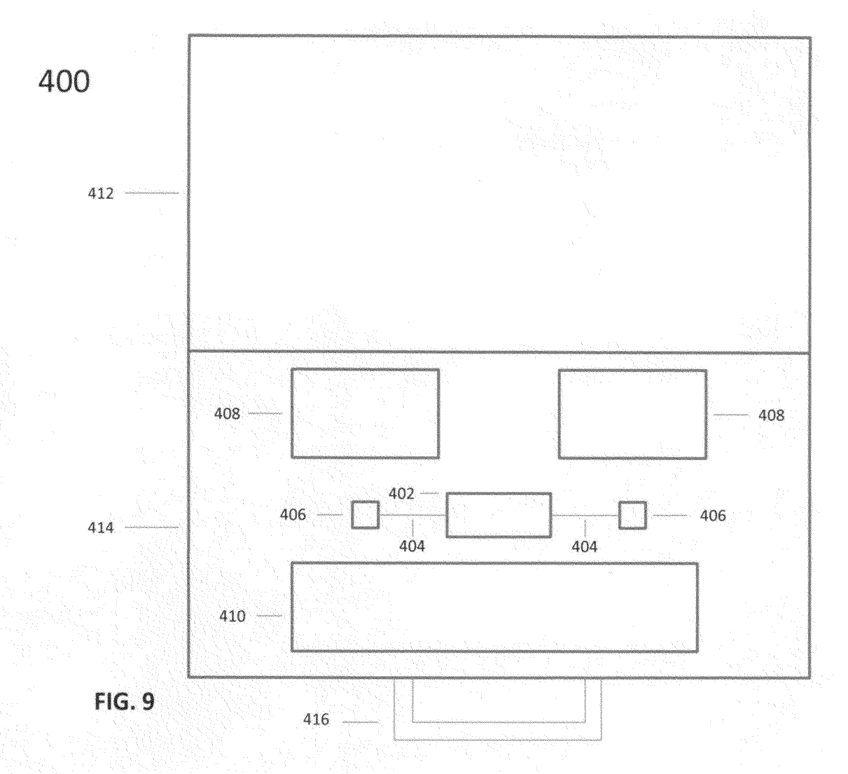

FIG. 9 shows a top view of one embodiment of an open case (400) according to the invention. Case bottom 414, as shown, includes a built in energy storage system 402 (e.g., fuel cell), which does not need to be charged using an external source. One or more (e.g., two) power-out bridges 404 transfer power from energy storage system 402 to one or more charge out slots 406, which can connect to one or more (e.g., two) cameras. The charge out slots can be of any suitable form, including, without limitation, the following: a USB; mini USB; micro USB; 9V out battery slot to charge batteries directly; camera dock to plug in camera directly. Case bottom 414 further includes one or more (e.g., two) camera storage sections 408, which can be of any suitable shape. One or more accessory storage sections 410 are optionally included—also of any suitable shape—as well as an optional handle 416. Case cover 412 is attached to case bottom 414 through a mechanism allowing it to open and close in connection with the bottom (e.g., hinge). In certain embodiments case cover 412 is detachable; in others it is not.

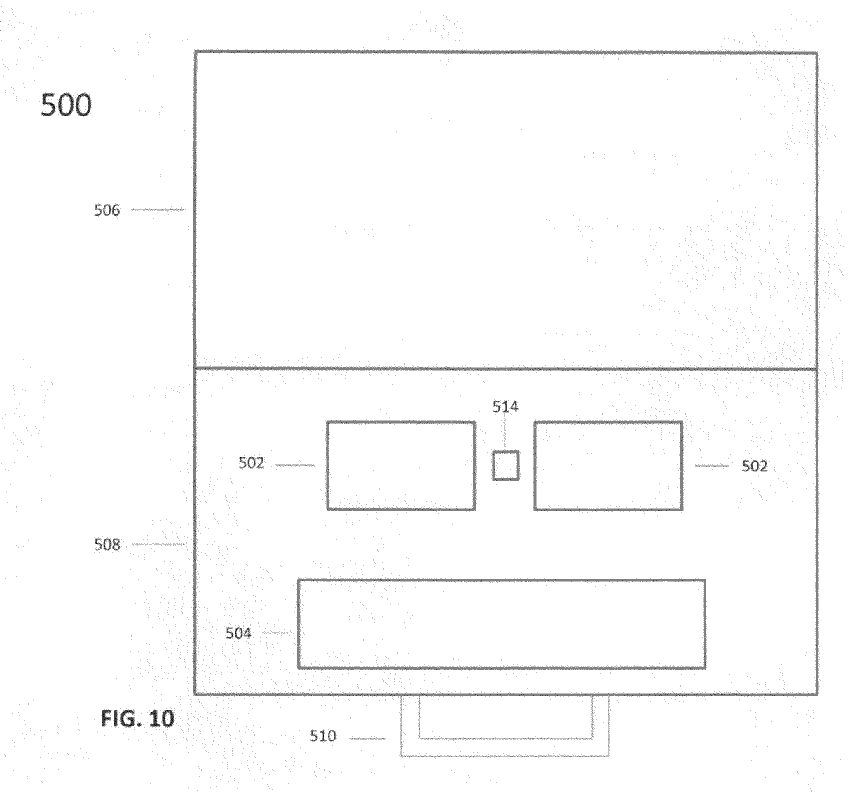

FIG. 10 shows a top view of one embodiment of an open case 500 according to the invention. Case bottom 508, as shown, includes a built in energy storage system 512 (not shown) which can charge a camera wirelessly (e.g., inductive charging), and which can be charged through a charge input (514). One or more cameras (e.g., two) can be charged using energy storage system 512 by placing them in one or more (e.g., two) storage sections 502 on top of energy storage system 512. One or more accessory storage sections 504 are optionally included, as well as an optional handle 510. Case cover 506 is attached to case bottom 508 through a mechanism allowing it to open and close in connection with the bottom (e.g., hinge). In certain embodiments case cover 506 is detachable; in others it is not.

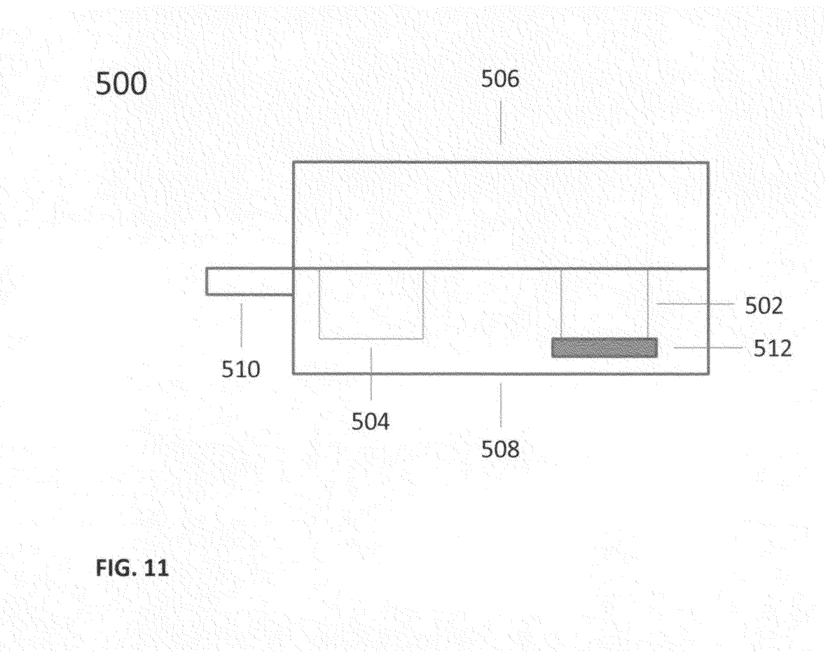

FIG. 11 shows a cut-away side view of one embodiment of a closed case (500) according to the invention. Case bottom 508 optionally includes at least one accessory section 504. One or more camera sections rest on top of wireless energy storage system 512. Optional handle 510 is attached to case bottom 508, and case cover 506 is closed on top of case bottom 508.

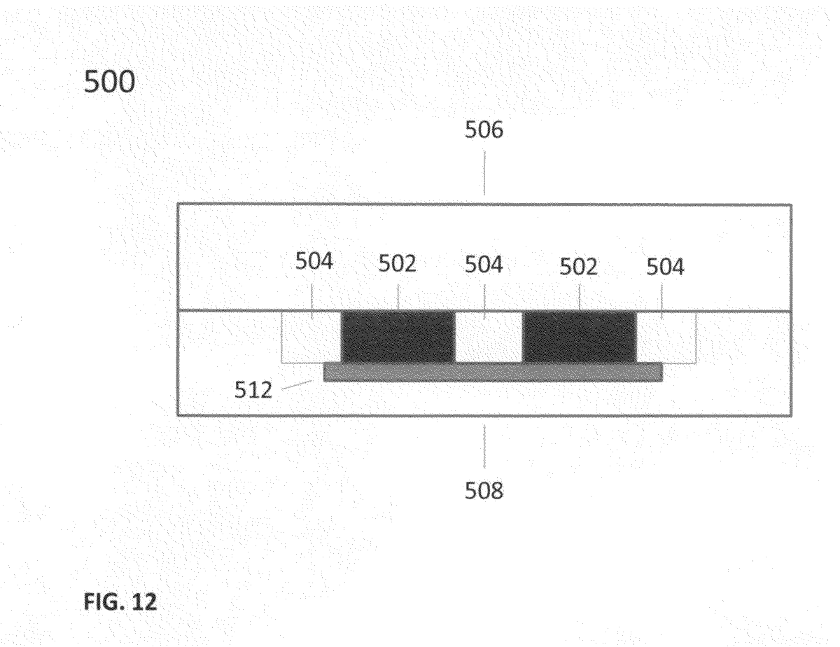

FIG. 12 shows a cut-away bottom view of one embodiment of a closed case (500) according to the invention. Case bottom 508 optionally includes at least one accessory section 504. As shown, two camera sections 502 rest on top of a wireless energy storage system 512. Case cover 506 is closed on top of case bottom 508.

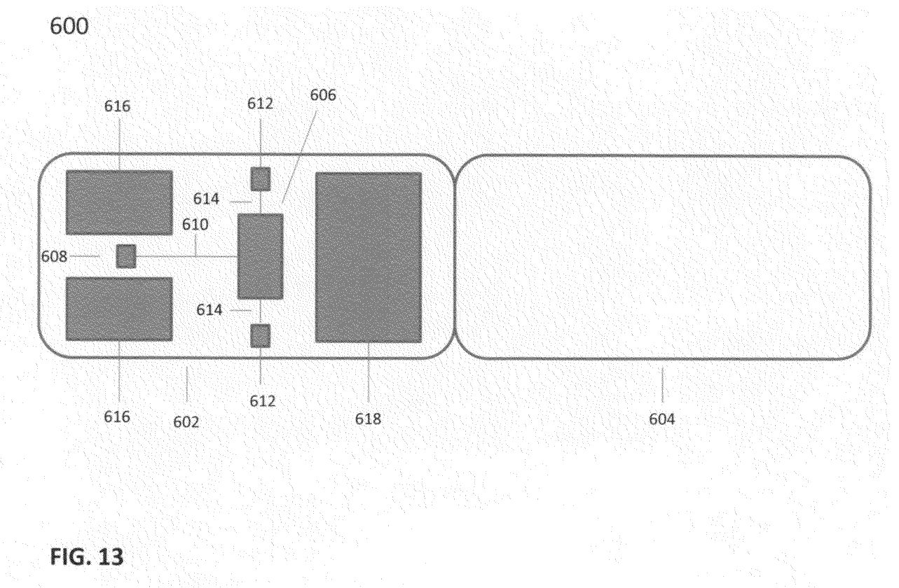

FIG. 13 shows a top view of one embodiment of an open bag according to the invention. Case bottom 602, as shown, includes a built in energy storage system 606 (e.g., battery), which can be charged through a charge input (608). The charge provided to charge input 408 can be from any suitable device, including, without limitation, the following: a USB; a mini USB; a micro USB; and a 9 V battery. Power-in bridge 610 transfers power from charge input 608 to energy storage system 606. One or more (e.g., two) power-out bridges 614 transfer power from energy storage system 606 to one or more charge out slots 612, which can connect to one or more cameras. The charge out slots can be of any suitable form, including, without limitation, the following: a USB; mini USB; micro USB; 9V out battery slot to charge batteries directly; camera dock to plug in camera directly. Case bottom 602 further includes one or more (e.g., two) camera storage sections 616, which can be of any suitable shape. One or more accessory storage sections 618 are optionally included—also of any suitable shape. Case cover 604 is attached to case bottom 602 through a mechanism allowing it to open and close in connection with the bottom (e.g., zipper, straps, clips, locks, clamp). In certain embodiments case cover 604 is detachable; in others it is not.

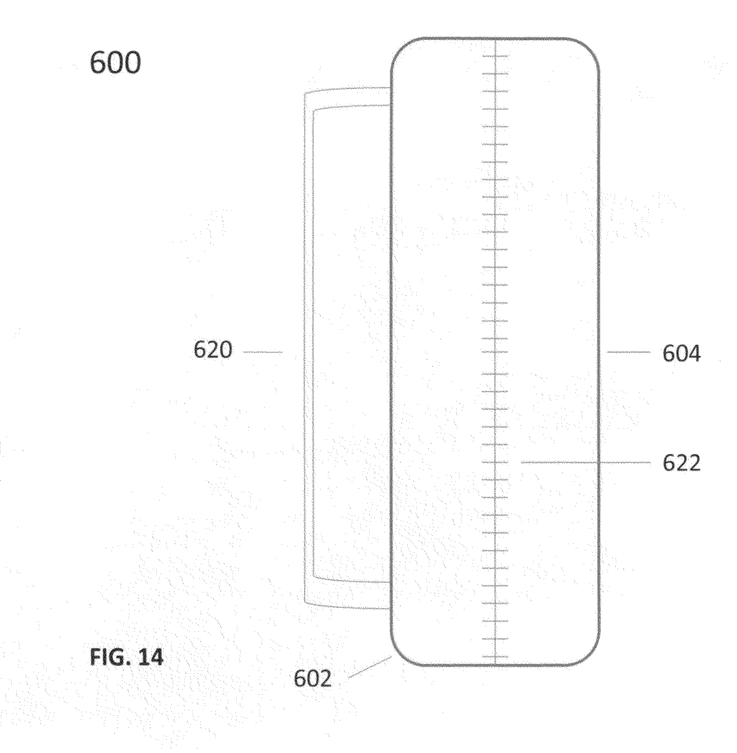

FIG. 14 shows a side view of one embodiment of a closed bag according to the invention. Case bottom 602 is connected to case cover 604 with zipper 622, although any suitable connection mechanism may be used. As shown, optional one or more straps (e.g., two) 620 is connected to case bottom 602.

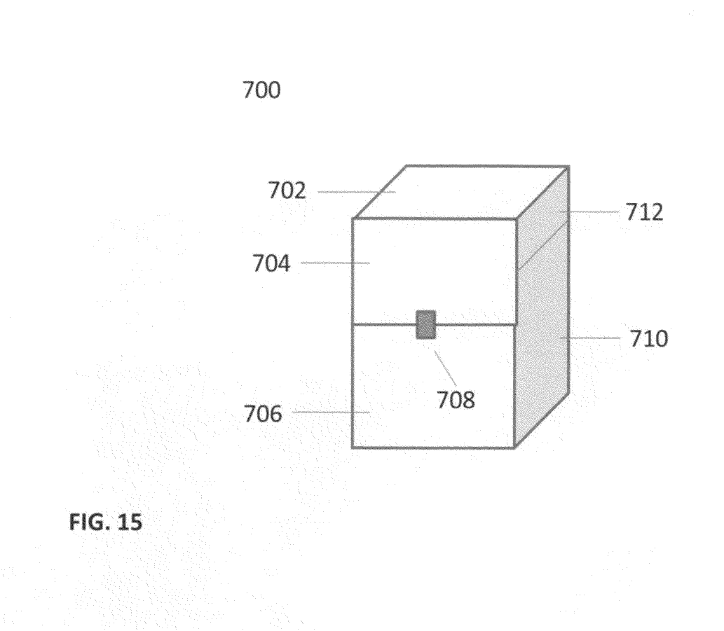

FIG. 15 shows a front view of one embodiment of a closed bag 700 according to the invention. Flap 704, which includes clasp 708 (although any suitable closure mechanism will work), is attached to top 702 and folds over front 706. The side (712) of top 702, when the bag is closed, is in contact with side 710.

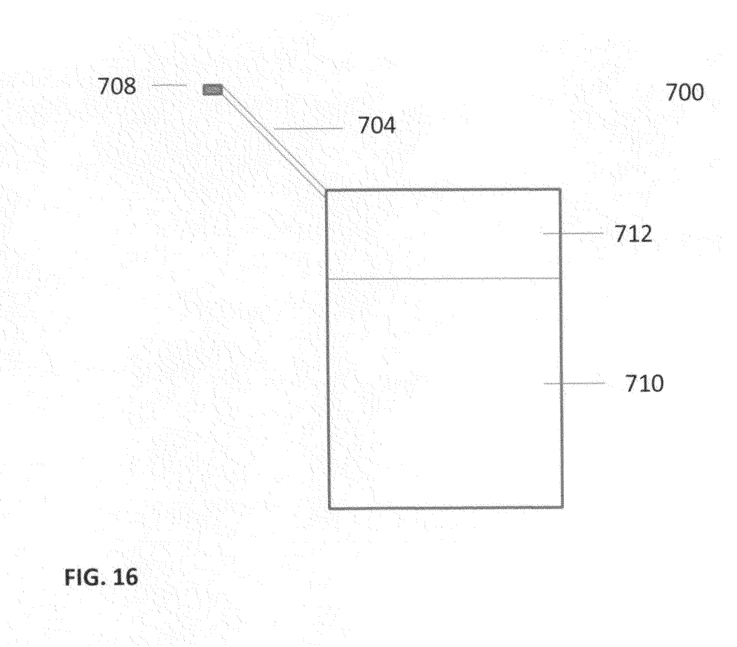

FIG. 16 shows a side view of one embodiment of an open bag according to the invention. Flap 704 is in an open position and is attached to clasp 708 and top 712. Side 710 is also shown.

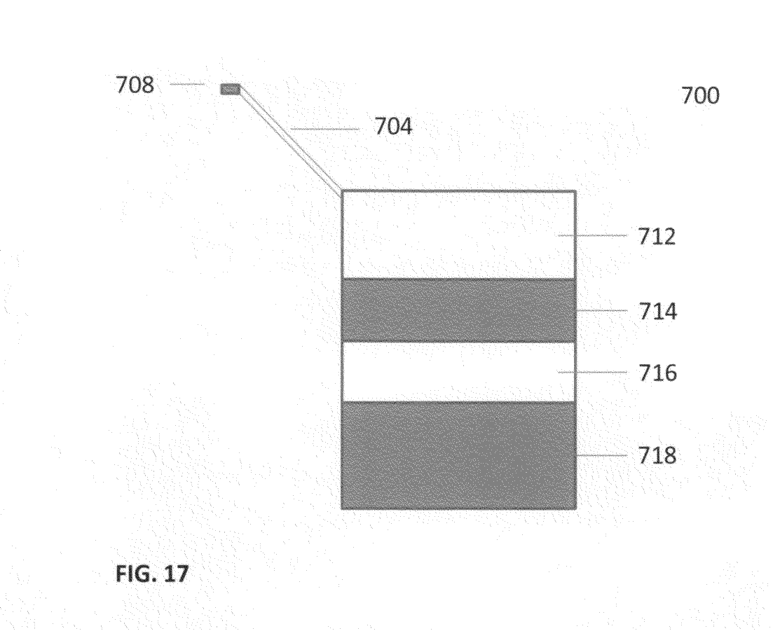

FIG. 17 shows a side view of one embodiment of an open bag where the outside of the bag has been cut away. As with FIG. 16, flap 704 is in an open position and is attached to clasp 708 and top 712. The side of three different storage sections is shown: a section that is capable of holding a camera (714, not shown); a section that includes an energy storage device (716, not shown); and a general storage section (718). It should be understood that the energy storage device section 716 could be above camera section 714 and that general storage section 718 could be above either of the other sections.

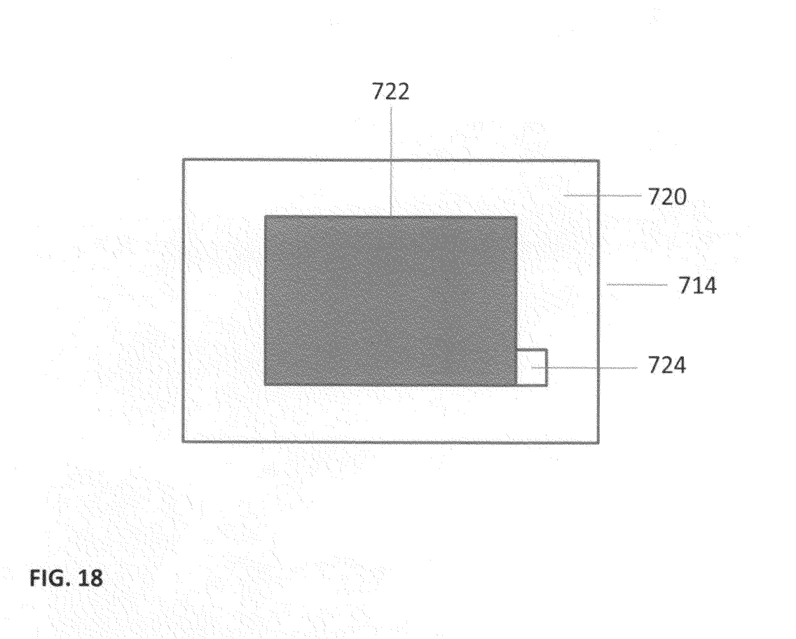

FIG. 18 shows a top view of one section of an embodiment according to the invention, where the section (720) is capable of holding a camera. At least one camera holding compartment (722) is included in section 720. When included in compartment 722, a battery can be operably connected to power out slot 724.

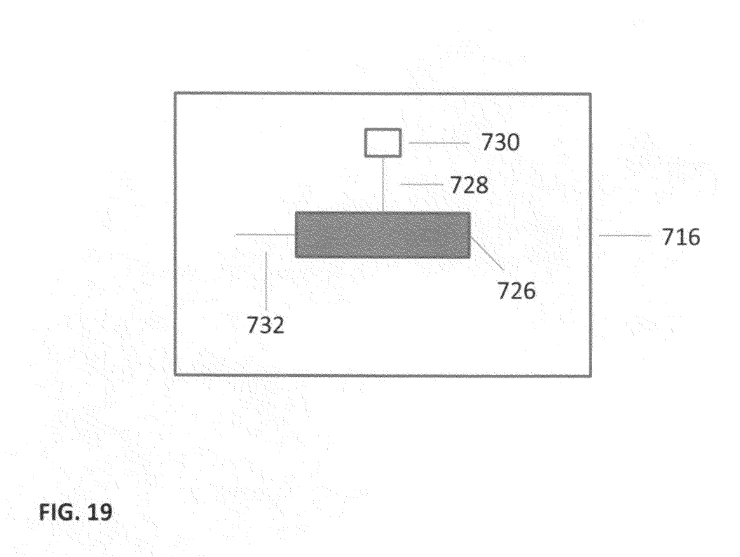

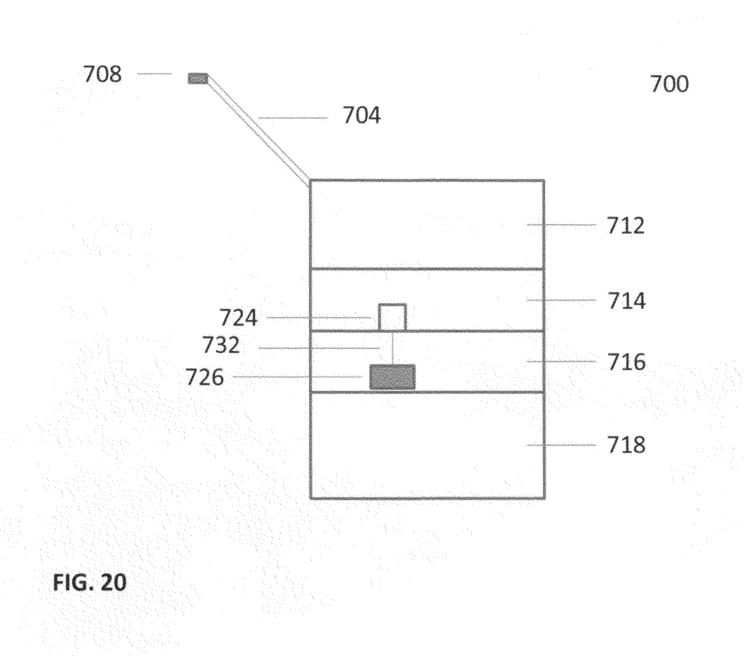

FIG. 19 shows a top view of one section of an embodiment according to the invention, where the section includes a power source (726, e.g., battery). Power source 726 is connected to power in bridge 728 which is connected to charge input 730. Power source 726 is further connected to power out bridge 732 as shown in FIG. 20.

FIG. 20 shows a cut away, side view of an embodiment of a bag (700) according to the invention. Flap 704 is in an open position and is attached to clasp 708 and top 712. Camera holding section 714, energy storage device section 716 and general storage 718 are shown. Energy storage device (e.g., battery) 726 is connected to power out bridge 732, which is connected to power out slot 724 situated in camera holding section 714.

The cases and bags of the present invention can be made of any suitable material. For example, the outside can be of soft-sided or hard-sided material. The inside, where the storage sections are present, can, for example, be made of a foam or other resilient polymer that can provide form fit around components. Elements such as solar cells, dynamos, fuel cells, etc. are made using standard methods known to those in the art.

1. A camera case or bag, wherein the case or bag comprises the following:
a) a case bottom, wherein the case bottom comprises a built in energy storage system and at least one camera storage section, and wherein the energy storage system can be operably connected to a camera placed in the camera storage section;
b) a case cover connected to the case bottom, such that the case cover can be closed on the case bottom.

2. The camera case or bag according to claim 1, wherein the energy storage system comprises a charge input attached to a power-in bridge that is operably connected to a battery, and wherein at least one power-out bridge operably connects the battery and a charge out slot.

3. The camera case or bag according to claim 1, wherein the energy storage system comprises a charge input attached to a power-bridge that is operably connected to a battery, and wherein at least one power-out bridge operably connects the battery to the camera storage section, where it can be directly attached to a camera.

4. The camera case or bag according to claim 1, wherein the energy storage system comprises a fuel cell that is operably connected to at least one power-out bridge that is operably connected to a charge out slot.

5. The camera case or bag according to claim 1, wherein the energy system comprises a charge input attached to a power-bridge that is operably connected to an inductive charger, and wherein at least one power-out bridge operably connects the inductive charger to the camera storage section where it can be directly attached to a camera.

6. The camera case or bag according to claim 2, wherein the charge input can be operably connected to a USB, mini USB, micro USB or 9V out battery slot.

7. The camera case or bag according to claim 2, wherein the charge input is operably connected to one or more solar panels or to a power generating system, and wherein the power generating system comprises a dynamo and a hand crank.
